(19) United States
(12) Patent Application Publication
(10) Pub. No.: US 2023/0409871 A1
(43) Pub. Date: Dec. 21, 2023

(54) Dimension Reduction and Principled Training on Hyperdimensional Computing Models

(71) Applicants: Northeastern University, Boston, MA (US); The Regents of the University of California, Riverside, CA (US)

(72) Inventors: Xiaolin Xu, Newton, MA (US); Shijin Duan, Boston, MA (US); Shaolei Ren, Irvine, CA (US)

(21) Appl. No.: 18/339,078

(22) Filed: Jun. 21, 2023

Related U.S. Application Data
(60) Provisional application No. 63/366,759, filed on Jun. 21, 2022.

(51) Int. Cl. G06N 3/04

(52) U.S. Cl. CPC G06N 3/04

(57) ABSTRACT

Embodiments determine inference classification for use on tiny devices. A processor is coupled with an item memory configured to store a plurality of binary vectors representing discrete values; a feature memory configured to store a plurality of binary vectors for instances of binary code; and an associate memory configured to store a plurality of predefined class vectors. Each of the plurality of discrete values associated with a feature vector are loaded from the item memory and mapped. The value vectors associated with the discrete values are stacked with one or more instances of binary code, such that the stacked dimension of the value vectors matches the dimension of the feature vectors. A matrix multiplication is performed on the stacked vectors to produce a sample vector. A comparison result is generated by comparing the sample vector against the class vectors, and the sample vector is classified based on the comparison results.

### RELATED APPLICATION

This application claims the benefit of U.S. Provisional Application No. 63/366,759, filed on Jun. 21, 2022. The entire teachings of the above application are incorporated herein by reference.

### BACKGROUND

Modern computing devices are capable of on-device inference. On-device inference is the localized computerized processing of input data, such as images or text, and identifying what that information is. by

### SUMMARY

Embodiments provide an improved method and system for inference classification on tiny devices.

One such example embodiment is a method for inference classification. The method comprises a circuit coupled with an item memory, where the item memory is comprised of a value memory configured to store a plurality of binary vectors which represent discrete values, a feature memory configured to store a plurality of query feature positions that are associated with the plurality of binary vectors in the value memory; and an associative memory configured to store a plurality of predefined class vectors. The method continues by mapping each of a plurality of discrete values, which are loaded from the value memory, to a plurality of instances of binary code. The method then stacks a plurality of value vectors associated with one or more of the plurality of discrete values associated with one or more instances of binary code. The dimension of the stacked value vectors will match the dimension of these value vectors with the dimension of the feature vector. The method then performs a matrix multiplication of the stacked value vectors and the feature vector in order to produce a sample vector. The method continues by generating a comparison result by comparing the sample vector against the plurality of predefined class vectors for similarity checking. Then, the method classifies the sample vector based on the comparison results associated with the similarities between the sample vector and the plurality of predefined class vectors.

In another embodiment, the method defines a neural network comprising a value layer, a feature layer, and a class layer. The embodiment continues by extracting a plurality of value vectors by inputting a plurality of values to the value layer. The value layer converts the feature values to bipolar value vectors, and records the output of the value layer. The embodiment then extracts a plurality of class vectors by recording a binary weight associated with each of the plurality of class vectors in the class layer. The plurality of class vectors have the same dimension as the plurality of value vectors and the plurality of feature vectors. A sample vector is defined as a product of binding the feature vector and the stacked value vectors.

The neural network may be a specialized neural network. A specialized neural network is a manually designed model structure. The specialized neural network has specialized structures for each layer, which corresponds to the cascaded realization in hyperdimensional computing (HDC).

In yet another embodiment, the circuit is implemented on a tiny device.

In an embodiment, the circuit is a field programmable gate array (FPGA).

In still another embodiment, the mapping of each of the plurality of discrete values associated with the feature vector to a plurality of instances of binary code is performed by a trainable neural network.

In another embodiment, the binary neural network is trained to optimize the organization of the plurality of instances of binary code by converting the value vectors to a low vector dimension.

Another embodiment provides a method for inference classification, comprising a processor coupled with an associative memory. The processor performs encoding a class vector for a class of data, the vector being determined by collecting a class of data and encoding the class of data with feature vectors and with value vectors. The method continues by calculating a class vector by averaging each of a plurality of hypervectors within the class, and storing the class vector in the associative memory.

In another embodiment, the class of data is a class of data of a plurality of classes of data.

In still another embodiment, the non-binary weights associated with the extracted value vectors are discarded.

In yet another embodiment, the class vectors from a set of optimized class weight parameters are extracted.

Another embodiment provides a system for inference classification, the system comprises an item memory. The item memory comprises a value memory configured to store a plurality of binary vectors representing discrete values, and a feature memory configured to store a plurality of query feature positions that are associated with the plurality of binary vectors in the value memory. The item memory also comprises an associative memory configured to store a plurality of predefined class vectors. The embodiment also comprise a circuit coupled with the item memory, the feature memory, and the associate memory. The circuit is configured to map a plurality of discrete values associated with a feature vector. The circuit is also configured to stack a plurality of value vectors associated with one or more of the plurality of discrete values associated with one or more instances of binary code, where the dimension of the stack of plurality of value vectors matches the dimension of the plurality of value vectors combined with a dimension of the feature vector. The circuit then compares a sample vector to each of a plurality of predefined class vectors by performing a matrix multiplication. The sample vector is a product of binding the feature vector and the stacked plurality of value vectors. The circuit identifies a respective value associated with similarity between the sample vector and each of the plurality of class vectors. The circuit then classifies the sample vector based on the maximum value associated with similarity with the plurality of predefined class vectors.

Another embodiment provides a method for inference classification. The method comprises a circuit coupled with an item memory. The item memory is comprised of a value memory configured to store a plurality of binary vectors which represent discrete values, a feature memory configured to store a plurality of query feature positions that are associated with the plurality of binary vectors in the value memory; and an associative memory configured to store a plurality of predefined class vectors. The circuit then combines the plurality of binary vectors with the plurality of query feature position, resulting in a sample vector. The circuit compares the sample vector to a plurality of class vectors of a class layer, which results in respective comparison scores for each comparison. Next, the circuit will output the comparison scores for the classification as an inference label.

In another embodiment, the combining of the plurality of binary vectors with the plurality of query feature positions includes multiplying each feature vector with each value vector, and accumulating the result of the multiplying resulting in the sample vector.

In still another embodiment, the multiplying and accumulating are performed by a field programmable gate array (FPGA).

In a further embodiment, comparing the sample vector to the plurality of class vectors includes multiplying the sample vector with each class vector and averaging the result of the multiplication to a scalar.

In another embodiment, one or more of the item memory, associative memory, and feature memory are 1 MB or less.

In yet another embodiment, the circuit includes less than 10,000 look up tables (LUTs).

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram illustrating an example embodiment of an exemplary tiny device for the inference process of the proposed LDC classifier, as disclosed herein.

FIG. 2 is a block diagram 200 illustrating an example an overview of an existing HDC model.

FIG. 3 is a block diagram 300 illustrating an example embodiment of an LDC classifier.

FIG. 4 is a diagram illustrating an exemplary encoding of a sample vector 401 by performing several binarizing of each respective feature 402a-b (attributes 1 . . . n) of a feature vector with each respective value 403a-b (values 1 . . . N) of a value vector, and performing a matrix multiplication to produce a sample vector 401.

FIG. 5A is a diagram illustrating an embodiment of mapping by current HDC classifiers.

FIG. 5B is a diagram illustrating an example of a ValueBox employed by the LDC classifier of the present disclosure.

FIG. 6 is a block diagram illustrating an example embodiment of the element-wise binding used by the encoder.

FIG. 7 is a diagram illustrating the classification process. In the LDC classifier, the classification process includes calculating the similarities between a query hyper-vector 701 and all class hypervectors 702.

FIG. 8 is a diagram illustrating an example embodiment of an end-to-end neural network constructed by integrating different stages of the LDC classification pipeline in an embodiment of the present disclosure.

FIG. 9 are images illustrating computer vision applications (MNIST and Fashion-MNSIT), as an example embodiment.

FIG. 10 is a graph illustrating an example embodiment of testing accuracy for different neural networks which are tested for the ValueBox and are also compared against two manual designs (fix-point encoding and thermometer encoding) in plot.

FIG. 11 is a plot illustrating example accuracy test data for the LDC classifier.

FIG. 12 is a plot illustrating an example robustness analysis for both LDC and HDC classifiers.

FIG. 13 is a diagram illustrating a computer network or similar digital processing environment in which embodiments of the present disclosure may be implemented.

FIG. 14 is a diagram illustrating the internal structure of a computer (e.g., client processor/device or server computers) in the computer system of FIG. 13.

### DETAILED DESCRIPTION

A description of example embodiments follows.

One example of on-device classification is a computer may be presented an image of a shirt. The computer identifies distinguishing features of the presented shirt, and compares those features to what the computer already knows makes up a shirt, thus identifying the object as a shirt.

By mimicking brain-like cognition and exploiting parallelism, hyperdimensional computing (HDC) classifiers are a lightweight framework to achieve efficient on-device inference. Nonetheless, HDCs have two fundamental drawbacks—a heuristic training process and ultra-high dimension—which result in suboptimal inference accuracy and large model sizes beyond the capability of tiny devices with stringent resource constraints.

Deploying deep neural networks (DNNs) for on-device inference, especially on tiny Internet of Things (IoT) devices with stringent resource constraints, presents a key challenge with legacy HDC because, in part, of the fundamental limitation of DNNs that involve intensive mathematical operators and computing beyond the capability of many tiny devices. In some embodiments, a tiny device can be a device with memories (e.g., item memory (including a value memory and a feature memory), associative memory) smaller than 1 MB each, look up tables under 10,000, using a FPGA to make calculations, or using power below a particular threshold.

More recently, inspired by analogy from the human-brain memorizing mechanism, hyperdimensional computing (HDC) for classification has been emerging as a lightweight machine learning framework targeting inference on resource-constrained edge devices. HDC classifiers mimic the brain cognition process by representing an object as a vector (e.g., a hypervector) with a very high dimension. The dimension can be on the order of thousands of bits, and potentially even higher numbers of bits. They perform inference by comparing the similarities between the hypervector of a testing sample and a set of pre-built hypervectors representing different classes. Thus, with HDC, the conventional DNN inference process is essentially projected to parallelizable bit-wise operation in a hyperdimensional space. This offers several key advantages to HDC over its DNN counterpart, including high energy efficiency and low latency, and hence makes HDC classifiers potentially promising for on-device inference. As a consequence, the set of studies on optimizing HDC classifier performance in terms of inference accuracy, latency and/or energy consumption has quickly expanding.

Current HDC classifiers suffer from fundamental drawbacks that prevent their successful deployment for inference on tiny devices. First, the hyperdimensional nature of HDC means that each value or feature is represented by a hypervector with at least several thousand bits, which can easily result in a prohibitively large model size beyond the limit of memory capacity of typical tiny devices. Further, parallel processing of a huge number of bit-wise operations associated with hypervectors is infeasible on tiny devices because it significantly increases the inference latency.

Furthermore, the energy consumption by processing hypervectors can also be a barrier for inference on tiny devices.

In addition, another drawback of HDC classifiers is the low inference accuracy resulting from the lack of a principled training approach. Concretely, the training process of an HDC classifier is extremely simple—simply averaging over the hypervectors of labeled training samples to derive the corresponding class hypervectors. Although some heuristic techniques (e.g., re-training and regeneration) have been recently added, the existing HDC training process still lacks rigorousness and heavily relies on a trial-and-error process without systematic guidance as in the realm of DNNs. In fact, even a well-defined loss function is lacking in the training of HDC classifiers.

As described above, legacy hyperdimensional computer (HDC) classifiers suffer from significant fundamental drawbacks, such as a heuristic training process and being of ultra-high dimensions. These drawbacks result in suboptimal inference accuracy and large model sizes. As such, legacy HDC classifiers are ill-suited for implementation on devices with stringent resource constraints, such as the resources available on “tiny devices.”

The present disclosure addresses the problems of the legacy HDC systems and discloses a solution of an efficient classification model based on low-dimensional computing (LDC) for inference on resource constrained tiny devices. A person of ordinary skill in the art understands that “low” is a relative term when compared to legacy HDC models, and is generally understood to mean a dimension of less than 100 in some embodiments. In some embodiments, low dimensional means having fewer than 150 dimensions.

By mapping the LDC classifier into an equivalent neural network, the model is optimized using a principled training approach. Most importantly, the inference accuracy can be improved while successfully reducing the ultra-high dimension of existing HDC models by orders of magnitude. For example, instead of a model size of 8000 bits which would be common in a HDC classifier model, the LDC classifier is capable of model sizes of just 4 bits or 64 bits, depending on the vector. For usage on tiny devices, the small model sizes result in an overwhelming advantage over the legacy, brain-inspired, HDC models.

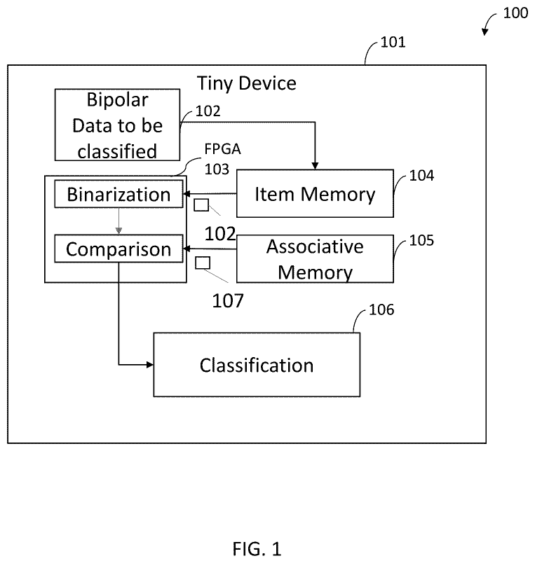

FIG. 1 is a block diagram 100 illustrating an example embodiment of an exemplary tiny device 101 for the inference process of the proposed LDC classifier, as disclosed herein. The processor 103 is coupled with an item memory (IM) 104 and an associative memory (AM) 105. The data to be classified 102, such as image or text data, is processed through the processor 103 and stored in the item memory 104. The data 102 that is outputted from the item memory 104 can be represented, in some embodiments, as bipolar, such as on a range of {−1,1}. A person of ordinary skill in the art can recognize that the data 102 is not limited to images or text data, and can include any type of data able to be classified, such as audio data, or other data. Processing the data 102 includes mapping a plurality of discrete values, loaded from the item memory 104, to a feature vector (F). The item memory 104 stores both feature vectors (F) and value vectors (V). In other embodiments, the data 102 can be provided to the item memory 104 directly as feature vectors and value vectors. The feature vectors and value vectors are then binarized via a matrix multiplication and accumulation operation by the binarization module of the FPGA 103, resulting in a sample vector (S). That sample vector (S), output from the binarization module, is then compared with a predefined class vectors (C) or class layer 107 which are stored in the associative memory 105. The result of that comparison results in a classification 106.

Embodiments described herein map the inference process of the LDC classifier into a neural network that includes a non-binary neural network and a binary neural network (BNN). This mapping optimizes the weights of the neural network. The method then extracts low-dimensional vectors representing object values and features from the optimized weights for efficient inference. Most crucially, the LDC classifier eliminates the large hypervectors used in the existing HDC models, and utilizes optimized low-dimensional vectors with a much smaller size to achieve even higher inference accuracy. For example, instead of a model size of 8000 bits, which would be common in a HDC classifier model, the LDC classifier is capable of model sizes of just 4 bits or 64 bits, depending on the vector. Thus, compared to the existing HDC models, the LDC classifier improves inference accuracy while dramatically reducing the model size, reducing inference latency, and reducing energy consumption by orders of magnitude.

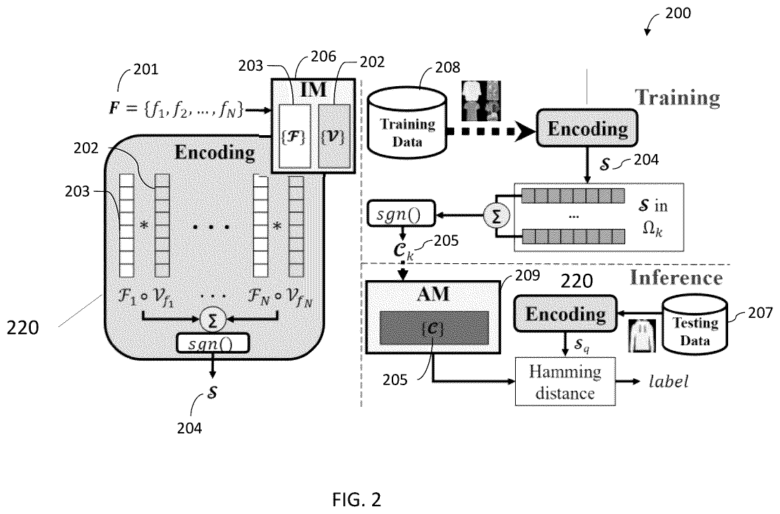

FIG. 2 is a block diagram 200 illustrating an example an overview of an existing HDC model. In this example, an input sample is represented as a vector 201 with N features F={f₁, f₂, . . . f_{N}}, where the value range for each feature is normalized and uniformly discretized into M values, i.e., fᵢ∈{1, . . . , M} for i=1, . . . , N. The HDC encodes all the values, features, and samples as hyperdimensional bipolar vectors, e.g., H∈{1, −1}^{D=10,000}, which also equivalently correspond to binary 0/1 bits for hardware efficiency. For the purposes of this application, the terms binary and bipolar are used interchangeably. The input vector 201 F={f₁, f₂, . . . , f_{N}} can represent raw features or extracted features (e.g., using neural networks and random feature map).

There are four types of hypervectors in HDC models:
a) Value hypervector(s) “V” 202 (representing the value of a feature),
b) feature hypervector(s) “F” 203 (representing the index/position of a feature),
c) sample hypervector(s) “S” 204 (representing a training/testing sample), and
d) class hypervector(s) “C” 205 (representing a class).

To measure the similarity between two hypervectors, there are two commonly used distances: a normalized Hamming distance and co-sine, which are mutually equivalent. For purposes of this disclosure, the normalized Hamming distance is defined as

$$Hamm ( {H}_{1} , {H}_{2} ) = \frac{{H}_{1} \neq {H}_{2}}{D} .$$

This numerator in this equation represents the number of bits that have corresponding values different between two hypervectors. The division over the dimension represents the ratio of not-equal bits on the two hypervectors, over the total number of bits. If two hypervectors H₁ and H₂ have a normalized Hamming distance of 0.5, they are considered orthogonal. In a hyperdimensional space, two randomly-generated hypervectors are almost orthogonal.

In a typical HDC model, the value and feature hypervectors 202 and 203 are randomly generated in advance and remain unchanged throughout the training and inference process. Commonly, N feature hypervectors F are randomly generated to keep mutual orthogonality (e.g., randomly sampling in the hyperdimensional space or rotating one random hypervector), whereas M value hypervectors V are generated to preserve their value correlations (e.g., flipping a certain number of bits from one randomly-generated value hypervector). As a result, the Hamming distance between any two feature hypervectors is approximately 0.5, while the Hamming distance between two value hypervectors denoting normalized feature values of i, j∈{1, . . . , M} is

$$Hamm ( {V}_{i} , {V}_{J} ) \approx \frac{\vert i - j \vert}{2 ( M - 1 )} .$$

An encoding module 220 encodes input sample as a sample hypervector 204 by fetching the pre-generated value and feature hypervectors 202 and 203 from the item memory (IM) 206. Specifically, by combining each feature hypervector 203 with its corresponding value hypervector 202, the encoding output for an input sample is given by: S=sgn (Σᵢ₌₁^{N}FᵢºV_{fi}) where fᵢ is the i-th feature value, V_{fi} is the corresponding value hypervector, is the Hadamard product, and sgn(·) is the sign function that binarizes the encoded sample hypervector. As a tiebreaker, sgn(0)=1.

Given K classes, the training process obtains K class hypervectors 205, each for one class. Training data 208 having data and annotations (e.g., a feature hypervector) is encoded into a sample vector S 205 using the encoding module 220. The training process averages the sample hypervectors 204 within a class using the equation Cₖ=sgn(Σ_{S∈Ω}_{ₖ}S), where Ωₖ is the set of sample hypervectors 204 in k-th class. The resulting class hypervectors 205 generated by the training are stored in the associative memory (AM) 209.

To improve accuracy, existing HDC models have also added re-training as part of the training process. Concretely, re-training fine tunes the class hypervectors C 205 derived as C k=sgn(Σ_{S∈Ω}_{ₖ}S). If a training sample 208 is misclassified, it is given more weights in correct class hypervector and subtracted from the wrong class hypervector. Essentially, re-training leads to an adjusted centroid for each class.

The testing input sample 207 is first encoded in the same way as encoding a training sample. To be distinguished from the training sample hypervector 208, the testing sample hypervector 207 is also referred to as a query hypervector. For inference, the query hypervector S_{q} is compared with all the class hypervectors 205 fetched from the associative memory 209. The most similar class hypervector 205 with the lowest Hamming distance indicates the classification result: arg min k Hamm(S_{q}, Cₖ).

Due to the equivalence of Hamming distance and cosine similarity, the classification rule (arg minₖ Hamm(S_{q}, Cₖ)) is equivalent to arg maxₖ S_{q}^{T} Cₖ which essentially transforms the bit-wise comparison to vector multiplication and is instrumental for establishing the equivalence between an HDC model and a neural network.

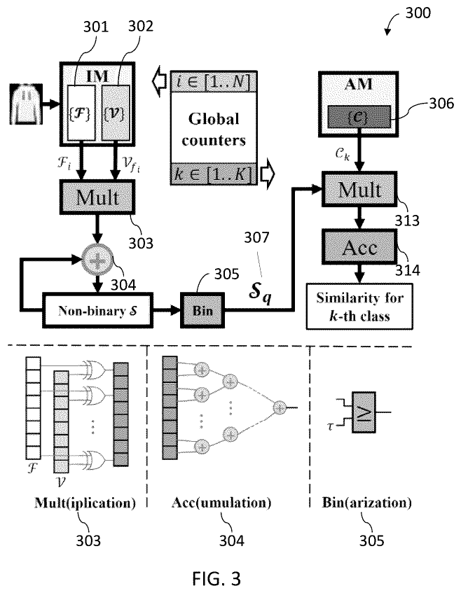

FIG. 3 is a block diagram 300 illustrating an example embodiment of an LDC classifier. In an embodiment, the LDC can be implemented using a field-programmable gate array (FPGA). The LDC classifier design uses a hardware-friendly association of low-dimensional vectors for efficient inference. Specifically, like in its HDC counterpart, the LDC classifier mimics brain cognition for hardware efficiency by representing features using vectors and performs inference via vector association. Nonetheless, the current HDC models rely on randomly-generated hypervectors, which not only limits the accuracy but also results in a large inference latency and resource consumption beyond the capability of tiny devices. The LDC classifier disclosed herein fundamentally differs from current HDC classifiers because it uses vectors with orders-of-magnitude smaller dimensions, and optimizes the vectors using a principled approach. In at least one embodiment, the LDC classifiers disclosed herein advantageously reduce memory requirements compared to current HDC classifiers.

The LDC still employs use of feature vectors (F) 301 and value vectors (V) 302. However, unlike in an HDC model that has the same hyperdimension of D for all hypervectors, feature vector (F) 301 and value vector (V) 302 can have different and much lower dimensions of D_{F} and D_{V}, respectively.

The LDC is implemented in hardware using bipolar values in the range of {1, −1} represented as binary values in the range of {0, 1}, respectively. The bipolar values of the feature vector (F) 301 and value vector (V) 302 are calculated with a multiplication operation 303 that includes XOR and popcount 303 and an addition operation 304 that includes tree adders, resulting in a binary representation 305.

The existing HDC models exploit full parallelism for acceleration. For example, given N features, the hardware of the existing HDC prepares N identical hypervector multiplication blocks to encode all the features simultaneously, incurring a high resource expenditure (e.g., over 10⁵ lookup tables (LUTs), 100 block random access memories (BRAMs), and 800 digital signal processors (DSPs) in SOTA FPGA acceleration). This HDC design does not fit into tiny devices, for which its resource utilization must be limited.

In contrast, the LDC of the present disclosure employs a pipeline structure for feature encoding, rather than in parallel, to fit into tiny devices. In reference to FIG. 3, example embodiments of the LDC can be implemented with just one vector multiplication block 303 and several (e.g., 1 to 6) BRAMs. Although the encoding time increases to N+1 cycles, the latency is still on a microsecond scale. Subsequently, one adder 304 is utilized to accumulate the multiplied vectors, followed by a threshold (τ=N/2) comparator 305 to binarize the encoding output (e.g., convert from bipolar values to binary values), resulting in sample vector S q 307.

For checking similarity, a pipeline structure is used for comparison on all class vectors 306. The sample vector S_{q} 307 is multiplied by each class vector 306 by multiplier 313, resulting in a respective multiplication result for each class vector. Then, a tree adder 314 along the vector dimension calculates the Hamming distance calculation. Finally, the Hamming distances are transferred back to a processor (e.g., a CPU or other processing device) to execute the arg min( ) function for classification.

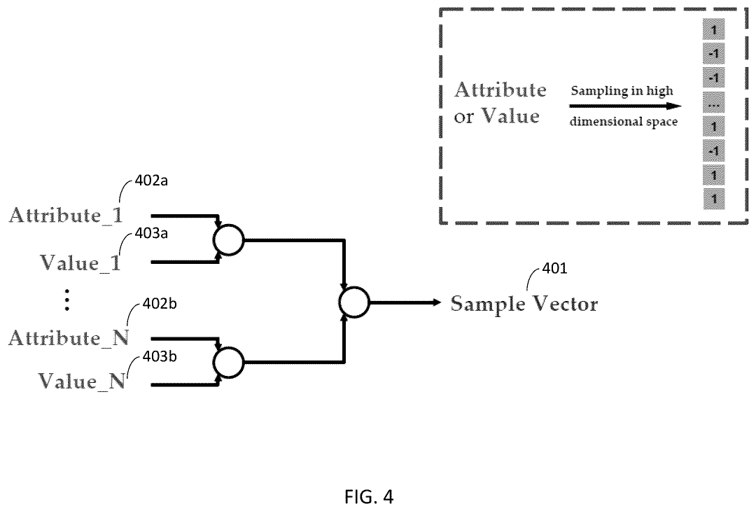

FIG. 4 is a diagram illustrating an exemplary encoding of a sample vector 401 by performing several binarizing of each respective feature 402a-b (attributes 1 . . . n) of a feature vector with each respective value 403a-b (values 1 . . . N) of a value vector, and performing a matrix multiplication to produce a sample vector 401. The LDC classification process is divided into two parts—encoding, illustrated in FIG. 4, and similarity checking—and are then mapped to an equivalent neural network operation.

The encoding process implemented by the LDC can also be expressed by the equation S=sgn (Σᵢ₌₁^{N}FᵢºV_{fi}). The encoding process binarizes the summed bindings of value vectors and feature vectors. Instead of using random vectors, as in existing HDC models, the LDC explicitly optimizes the value and feature vectors by representing the encoder as a neural network and then uses a principled training process.

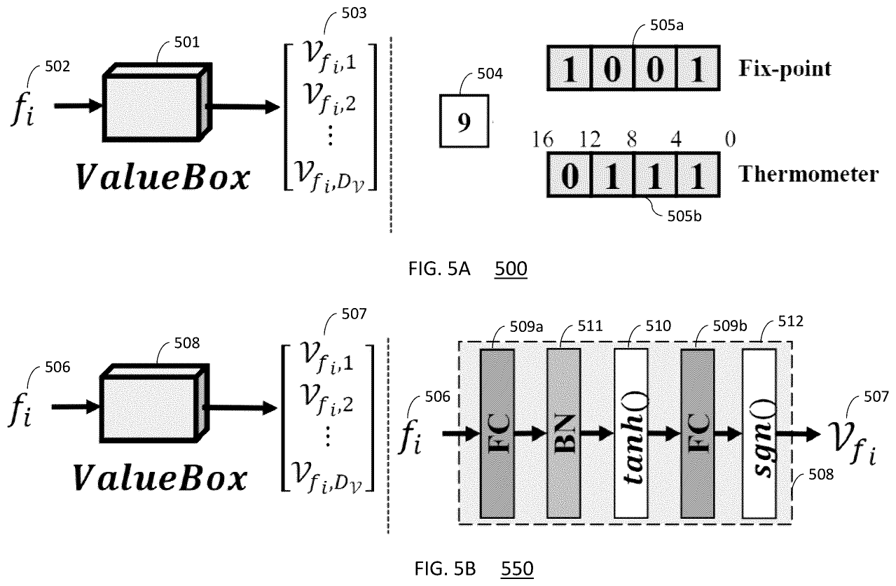

FIG. 5A is a diagram 500 illustrating an embodiment of mapping by current HDC classifiers. The ValueBox 501 performs a mapping functionality from a feature to a value vector V_{fi} 503. V_{fi} 503 is represented as a discretized feature value fᵢ∈{1, . . . , M} 502 with a certain (bipolar) vector. Current HDC models, in contrast, essentially assign a random hypervector to a feature value. Alternatively, one may manually design a ValueBox 501, e.g., representing a value 504 directly using its binary code 505a, or thermometer notation 505b.

FIG. 5B is a diagram 500 illustrating an example of a ValueBox 508 employed by the LDC classifier of the present disclosure. The LDC classifier employs the strong representation power of neural networks by using a trainable neural network for the ValueBox. For example, FIG. 5B illustrates a simple fully-connected neural networks 509a-b with batch normalization 511, tanh 510 activation, and the sgn ( ) function 512 to map a feature fᵢ 506 to a binary value vector V_{fi} 507. ValueBox 508 network is jointly trained together with subsequent operators to optimize the inference accuracy.

As shown by the equation S=sgn (Σᵢ₌₁^{N}fᵢºV_{fi}), the encoder binds the feature and value vectors using a Hadamard product. However, in the LDC classifier, the dimensions of the feature vector is not required to match the dimensions of the value vector (e.g., D_{F}=D_{V} is not required) which makes the Hadamard product inapplicable. Instead, D_{F} is set as an integer multiple of D_{V} (e.g., D_{F}/D_{V}=n, for n∈N⁺). As a result, a value vector V_{fi} can be stacked for n times in order to have the same dimension as its corresponding feature vector Fᵢ for Hadamard product. Equivalently, a feature vector can be evenly divided into n parts or sub-vectors, each aligned with the value vector for Hadamard product. Thus, the binding for the i-th feature vector and its corresponding value vector can be represented as:

$$[ \begin{matrix}{ℱ}_{i}^{1} ∘ {𝒱}_{fi} \\ … \\ {ℱ}_{i}^{n} ∘ {𝒱}_{fi}\end{matrix} ] = [ \begin{matrix}diag ( {ℱ}_{i}^{1} ) \\ … \\ diag ( {ℱ}_{i}^{n} )\end{matrix} ] {𝒱}_{fi}$$

Through element-wise binding, the encoder outputs a sample vector given by:

$$𝒮 = sgn ( {\sum }_{i = 1}^{N} [ \begin{matrix}diag ( {ℱ}_{i}^{1} ) \\ … \\ diag ( {ℱ}_{i}^{n} )\end{matrix} ] {𝒱}_{fi} )$$

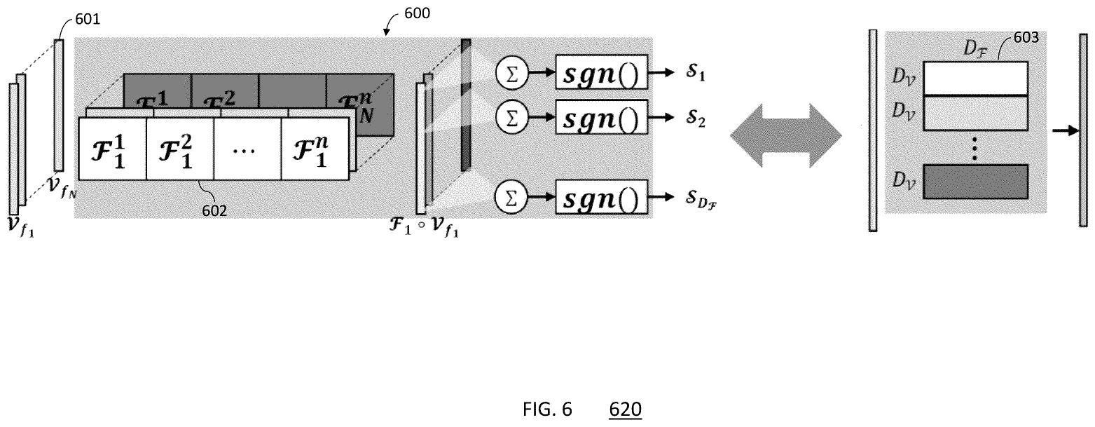

FIG. 6 is a block diagram 620 illustrating an example embodiment of the element-wise binding used by the encoder. Th element-wise binding is equivalently mapped to matrix multiplication in the above equation. A BNN can represent such a binding, and can be referred to as a feature layer. Specifically, by stacking N value vectors V_{fi} 601 for i=1, . . . , N, the input to the feature layer 600 is a vector with N D_{V} elements 603. The structurally sparse weight matrix Θ in the feature layer 600 is the collection of feature vectors Fᵢ 602 for i=1, . . . , N, with only N D_{F} bipolar elements in total. By transforming the encoder into an equivalent BNN, a principled training process is leveraged to optimize the weight matrix Θ, which generates an optimized feature vectors Fᵢ 602 having small dimensions (e.g., a vector of D_{F}×D_{V}), instead of random hypervectors with large dimensions used by the existing HDC models. The feature layer can then output the sum of the products of the feature vector and value vector, as described above, to provide a plurality of sample vectors S₁-S_{DF}.

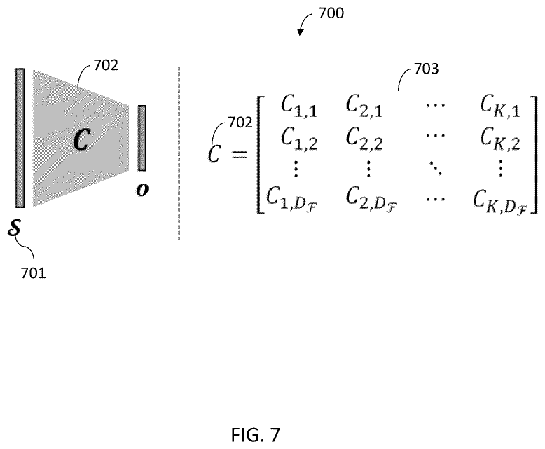

FIG. 7 is a diagram 700 illustrating the classification process. In the LDC classifier, the classification process includes calculating the similarities between a query hyper-vector 701 and all class hypervectors 702. Specifically, as shown in the equations arg min k Hamm(S_{q}, Cₖ) and arg maxₖ S_{q}^{T} Cₖ, the similarity check is equivalent to matrix calculation 703, which can also be mapped to the operation in a BNN. Hence, arg maxₖ S_{q}^{T} Cₖ is transformed into a class layer 703. The input to the class layer is the sample vector 701, which is also the output of the preceding feature layer 600 in FIG. 6. The weight of the class layer is a D_{F}×K matrix that represents the collection of all the class vectors Cₖ for k=1, . . . , K. The output of the class layer includes K products, and class k with the maximum product S^{T} Cₖ is chosen as the classification result.

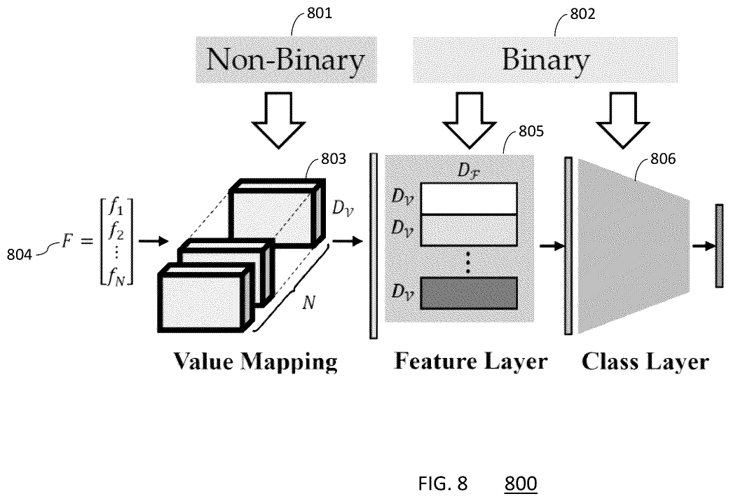

FIG. 8 is a diagram 800 illustrating an example embodiment of an end-to-end neural network constructed by integrating different stages of the LDC classification pipeline in an embodiment of the present disclosure. With both non-binary weights 801 from the value box 803 and binary weights 802, the neural network achieves the same function as the LDC classifier, and this equivalence allows a principled training approach to optimize the weights.

Specifically, in the equivalent neural network, each of the N feature values of an input sample 804 is input to a ValueBox 803, which is a non-binary neural network 801 that outputs bipolar value vectors. A single ValueBox is shared by all features to keep the model size small, while the LDC design can easily generalize to different ValueBoxes for different features at the expense of increasing the model size (in particular, the size of item memory). Then, the N value vectors outputted by the Valuebox 803 are inputted to a feature layer 805, which is a structurally sparse BNN. The feature layer 806 outputs a sample vector. Finally, the sample vector is input to a class layer 806, which calculates similarity (e.g., by matrix multiplication) of the sample vector to each of class of the layer, and a most similar class can be selected.

The present LDC classifier provides several advantages over current HDC classifiers. First, LDCs provide the advantage of using less memory with lower dimensional representations, compared to the obvious drawback of ultra-high dimension using more memory in HDS. Second, casting an existing HDC model into the equivalent neural network is another drawback. Concretely, the HDC ValueBox outputs and the feature layer weights corresponding to an HDC model are essentially randomly generated, and even the weights in the class layer (i.e., K class hypervectors in an HDC model) are obtained by using simple averaging methods in conjunction with heuristic re-training. Thus, the inference accuracy in the existing HDC models are highly sub-optimal.

To address the fundamental drawbacks of existing HDC models and maximize the accuracy with a much smaller model size, the LDC is trained to optimize the weights in its equivalent neural network that has both non-binary weights (e.g., in the ValueBox) and binary weights (e.g., in the feature layer and class layer). In one embodiment, following training methods for BNNs, “Adam” is used with weight decay as the optimization method and use softmax activation with CrossEntropy as the loss function. Due to the equivalence of Hamming distance and cosine similarity metrics for binary vectors, classification based on the largest softmax probability (e.g., arg maxₖ S_{q}^{T} Cₖ) is equivalent to classification based on the minimum normalized Hamming distance. Additionally, while CrossEntropy is commonly used for classification tasks, other loss functions such as hinge loss can be used. For training, the learning rate is set by starting with a large value (such as 0.001) with decaying linearly.

After training, the vectors used in the LDC classifier can be extracted as follows for testing. The value vectors V can be extracted from the ValueBox by recording the output corresponding to each possible input. For example, the value vector (V_{f}) for a certain feature value f is retrieved by ValueBox(f). Due to D_{F}/D_{V}=n for Hadamard product, the value vector is stacked n times in the encoder to align with the dimension of feature vectors. Thus, the non-binary weights in the ValueBox are not utilized for inference after extraction of the value vectors. For the purposes of the classification being conducted, the binary weights can be considered discarded once the value vectors are extracted.

The feature vectors F are extracted from the weight matrix in the feature layer. For the i-th feature, the feature vector Fᵢ can be extracted from the corresponding values in the i-th weight matrix block:

$$[ \begin{matrix}{ℱ}_{i , 1}^{1} & 0 & … & 0 & … & {ℱ}_{i , 1}^{n} & 0 & … & 0 \\ 0 & {ℱ}_{i , 2}^{1} & … & 0 & … & 0 & {ℱ}_{i , 2}^{n} & … & 0 \\ ⋮ & ⋮ & ⋱ & ⋮ & … & ⋮ & ⋮ & ⋱ & ⋮ \\ 0 & 0 & … & {ℱ}_{i , {D}_{𝒱}}^{1} & … & 0 & 0 & … & {ℱ}_{i , {D}_{𝒱}}^{n}\end{matrix} ]$$

such that Fᵢ is composed of [Fᵢ¹, Fᵢ², . . . , Fᵢⁿ] with dimension D_{F}, where [F_{i,1}^{j}, . . . , F_{i,D}_{_{V}}^{j}] for j=1, 2, . . . , n.

As shown by class layer 703, the class vectors C can be directly extracted from the weight matrix in the class layer 703. The extracted value and feature vectors are stored in the item memory for encoding, and the class vectors are stored in the associative memory for similarity checking.

For inference, the LDC classifier follows the encoding and similarity checking process as described above. Specifically, each feature value of an input sample is first mapped to a value vector, which is then combined with the corresponding feature vector to form a query sample vector. The query vector is compared with the class vectors for similarity checking and yielding the classification results. In most existing BNNs, the fully-connected layers use non-binary weights, which can slow down the inference process on tiny devices. In contrast, although the offline training process involves non-binary weights in the ValueBox neural network, the inference process of the LDC classifier is fully binary by utilizing bit-wise operation and association for classification.

The performance of the LDC classifier is evaluated on different datasets and highlight that it offers an overwhelming advantage over the SOTA HDC models: better accuracy and orders-of-magnitude smaller dimension. Like in the existing HDC research, four application scenarios are selected for inference on tiny devices.

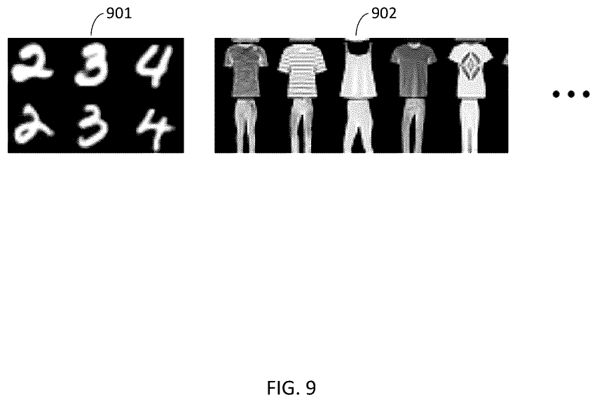

FIG. 9 are images illustrating computer vision applications (MNIST 901 and Fashion-MNSIT 902), as an example embodiment. However, human activity (UCIHAR), voice recognition (ISOLET), and cardiotocography (CTG) are also non-limiting applications. Each feature value is normalized to [0, 255] and quantized to an 8-bit integer. The configurations for each dataset below in Table 1,

TABLE 1

| Dataset | N | # of (train, test, class) | [symbol] | LR¹ | WD² |
|---|---|---|---|---|---|
| MNIST | 784 | (60000, 10000, 10) | 4, 64 | 0.0001 | 0 |
| Fashion- | 784 | (60000, 10000, 10) | 4, 64 | 0.0002 | 0.00001 |
| MNIST | | | | | |
| UCIHAR | 561 | (7352, 2947, 6) | 4, 128 | 0.001 | 0.0001 |
| ISOLET | 617 | (6328, 1559, 26) | 4, 128 | 0.005 | 0.0001 |
| CTG | 21 | (1701, 425, 3) | 4, 64 | 0.008 | 0.0001 |

¹LR = Learning Rate
²WD = Weight Decay

The LDC is compared with the existing HDC model with re-training, and the existing HDC model without re-training. As reported in, the HDC accuracy has significant reduction when the hypervector dimension is lower than 8,000 bits. Thus, D=8,000 is used for evaluating both current HDCs. For training, all the experiments are executed in Python with Tesla V100 GPU. For the inference, a hardware acceleration platform is built on a Zynq UltraScale+ZU3EG FPGA embedded on the Ultra96 evaluation board.

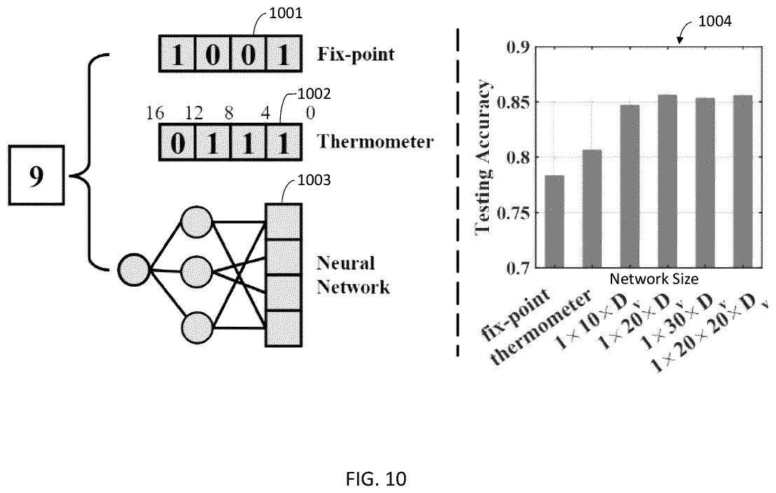

FIG. 10 is a graph illustrating an example embodiment of testing accuracy for different neural networks which are tested for the ValueBox and are also compared against two manual designs (e.g., fix-point encoding 1001 and thermometer encoding 1002) in plot 1104. D_{V}=8 is set to make fix-point encoding 1001 and thermometer encoding 1002 capable of representing 256 values. Considering the Fasion-MNIST dataset, the neural networks 1003 can discover better ValueBoxes than manual designs to achieve higher accuracy. On the other hand, it has no significant differences by varying the network size, such as 1×10×D_{V} vs. 1×20×D_{V}. In these experiments, 1×20×D_{V} is used for the neural network in the ValueBox.

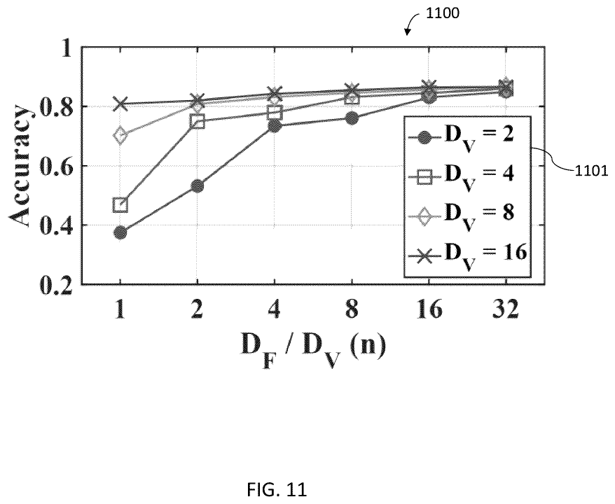

FIG. 11 is a plot 1100 illustrating example accuracy test data for the LDC classifier. The dimensions D_{V} and D_{F} used in the LDC classifier are important hyperparameters. Fashion-MNIST is used to evaluate the impact of D_{V} and D_{F} on the accuracy. By setting different n=D_{F}/D_{V}, the values of D_{V}=2, 4, 8, 16 co-vary, as presented in 1101. In general, a higher D_{V} retains richer information about the input, thus yielding a higher accuracy. Nonetheless, even with D_{V}=2 or D_{V}=4, a reasonably good accuracy is still achieved by increasing D_{F}. In all cases, the LDC dimensions are orders-of-magnitude smaller than the dimensions of 8,000 bits or higher in existing HDC models.

In the following table, the inference accuracy that LDC can achieve is evaluated compared to both basic and SOTA HDC models. The result shows that LDC can outperform existing HDC models that use random value/feature vectors and heuristically generate class vectors. While retraining improves the inference accuracy against the basic HDC, the hypervector dimension must be as large as 8,000 bits to prevent accuracy degradation. By contrast, the LDC classifier reduces the dimension significantly, without introducing any extra cost during the inference process, as shown below in Table 2.

TABLE 2

| Classifier | MNIST | Fashion-MNIST | UCIHAR | ISOLET | CTG |
|---|---|---|---|---|---|
| LDC | 92.72 ± 0.18 | 85.47 ± 0.29 | 92.56 ± 0.41 | 91.33 ± 0.50 | 90.50 ± 0.46 |
| Basic HDC | 79.35 ± 0.03 | 69.11 ± 0.03 | 89.17 ± 0.16 | 85.90 ± 0.25 | 71.35 ± 0.76 |
| SOTA HDC [15] | 87.38 ± 0.21 | 79.24 ± 0.52 | 90.31 ± 0.06 | 90.66 ± 0.31 | 89.51 ± 0.43 |

The below Table 3 shows the efficiency results of an LDC classifier.

TABLE 3

| Dataset | Name | Accuracy (%) | Platform | Model Size (KB) | Latency (μs) | (LUT, BRAM, DSP) | Energy (nJ) |
|---|---|---|---|---|---|---|---|
| MNIST | LDC | 92.72 | Zynq UltraScale+ | 6.48 | 3.99 | (745, 5, 1) | 64 |
| | SOTA HDC | 87.38 | Zynq UltraScale+ | 1050 | 499 | (768, 178, 1) | 36926 |
| | FINN [35] | 95.83 | Zynq-7000 | 600 | 240 | (5155, 16, —) | 96000 |
| CTG | LDC | 90.50 | Zynq UltraScale+ | 0.32 | 0.14 | (345, 3, 1) | 0.945 |
| | SOTA HDC | 89.51 | Zynq UltraScale+ | 2 [symbol] 0 | 16.88 | (362, 9, 1) | 169 |
| | Compressed HDC [2] | ~82 | Odroid XU3 | 45.1 | 90 | NA | 6300 |

[symbol]

indicates data missing or illegible when filed

For the test, LDC classifier is implemented on a field-programmable gate array (FPGA) platform under stringent resource constraints. The results show that, in addition to the improved accuracy (92.72% vs. 87.38%) on MNIST, the LDC classifier has a model size of 6.48 KB, inference latency of 3.99 microseconds, and inference energy of 64 nanojoules, which are 100+ times smaller than a SOTA HDC model; for cardiotocography application, the LDC achieves an accuracy of 90.50%, with a model size of 0.32 KB, inference latency of 0.14 microseconds, and inference energy of 0.945 nanojoules. The overwhelming advantage of the LDC classifier disclosed herein over the existing HDC models makes the LDC classifier particularly appealing for inference on tiny devices.

With the focus on tiny devices, the resource utilization is limited, e.g., <1 MB model size and <10k LUT utilization. To evaluate the existing HDC models, for fair comparison, the current HDC classifier with D=8, 000 is implemented using acceleration designs. Moreover, two other lightweight models are used for comparison: a compressed HDC model that uses a small vector but has non-binary weights and per-feature ValueBoxes founded using evolutionary search; and SFC-fix with FINN that applies a 3-layer binary MLP on FPGA. For these models, only their results available for the considered datasets are reported. The results are measured for model inference only, excluding data transmission between the FPGA and CPU.

For the MNIST dataset, by reducing the dimension of current HDC models by 125 times, the model size of LDC is only 6.48 KB. Further, the low dimension can benefit the resource utilization and execution time. For the current HDC model with D=8, 000, the number of BRAMs increases greatly to store all hypervectors, but other resources such as LUT and DSP do not increase dramatically due to sequential execution to account for tiny devices; consequently, the latency increases by 125 times. For energy consumption, the result shows that the LDC classifier has the lowest, because of the very low resource utilization and short latency. For the CTG dataset, the results are even more impressive as shown in the above table.

While inefficient, a natural byproduct of the hyperdimensionality of HDC classifiers is the robustness against random hardware bit errors. By contrast, the LDC classifier reduces the dimension by orders of magnitude and hence might become less robust against random bit errors.

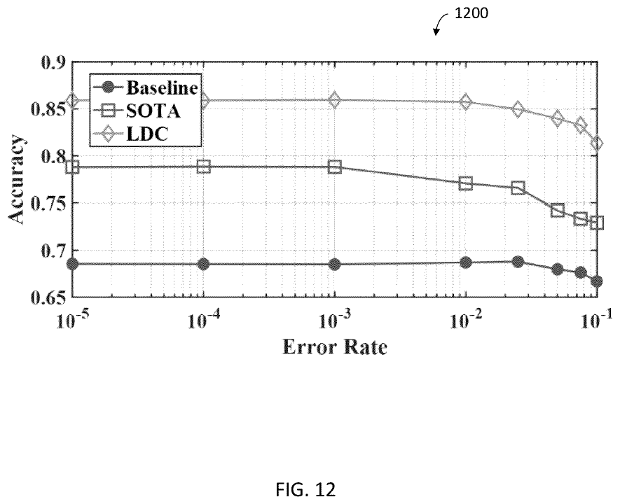

FIG. 12 is a plot 1200 illustrating an example robustness analysis for both LDC and HDC classifiers. Specifically, bit errors are injected in the associative memory under various bit error rates, and assess the inference accuracy caused by the injected bit errors. It is shown that the LDC classifier has the highest accuracy and also achieves comparable robustness on a par with the HDC counter-parts. The counter-intuitive results can be explained by the fact that, although the LDC classifier significantly reduces dimensions, the information is still spread uniformly within each compact vector (e.g., different bits are equally important), thus exhibiting robustness against random bit errors.

Multiple LDC classifiers can be run and apply the majority rule for better robustness. Due to the orders-of-magnitude dimension reduction, the total size of multiple LDC classifiers is still much less than that of a single HDC classifier.

The set of applications with HDC classifiers have been proliferating, include language classification, image classification, emotion recognition based on physiological signals, distributed fault isolation in power plants, gesture recognition for wearable devices, seizure onset detection, and robot navigation.

Nonetheless, the training process for existing HDC classifiers is mostly heuristics-driven and often relies on random hypervectors for encoding, resulting in low inference accuracy. In many cases, even a well-defined loss function is lacking for training HDC classifiers. Some systems learn a neural network model based on non-binary hypervector representations, and use generalized learning vector quantization (GLVQ) to optimize the class vectors. But, these systems consider hyperdimensional representations based on random hypervectors, thus resulting in an overly large model size.

In addition, the ultra-high dimension is another fundamental drawback of HDC models. Simply reducing the dimension without fundamentally changing the HDC design can dramatically decrease the inference accuracy. Moreover, it uses different sets of value vectors for different features, and hence results in a large model size Also, its training process is still heuristic-driven as in the existing HDC models. By sharp contrast, the LDC classifier is optimized based on a principled training approach guided by a loss function, and offers an overwhelming advantage over the existing HDC models, in terms of accuracy, model size, inference latency, and energy consumption.

The LDC classifier is relevant to but also differs significantly from BNNs which use binary weights to speed up inference. To avoid information loss, non-binary weights are still utilized in the early stage of typical BNNs which may not be supported by tiny devices, whereas the inference of the LDC classifier is fully binary and follows a brain-like cognition process. Manually designs the value mapping from raw features to binary features. In the LDC design, a neural network is used to automatically learn the mapping which, as shown in plot 1004, outperforms manual designs in terms of accuracy.

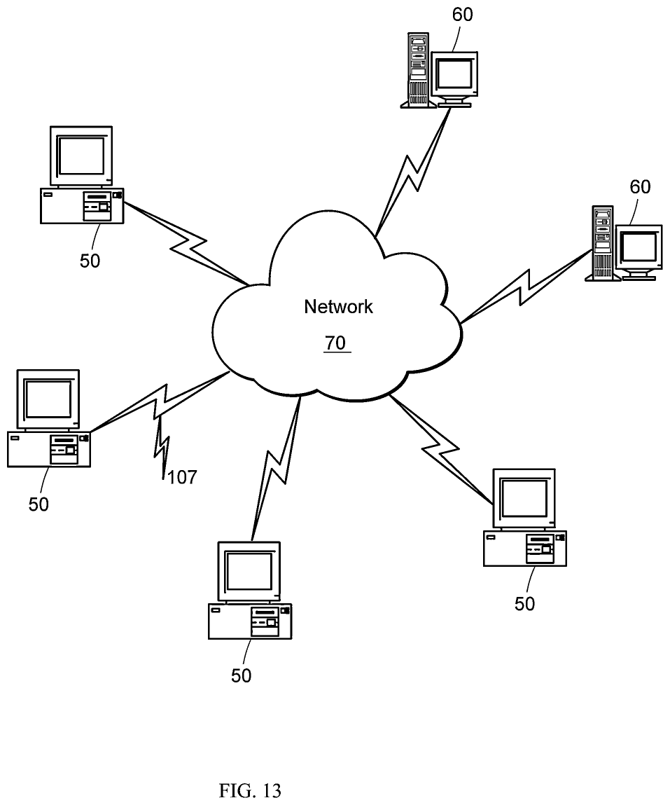

FIG. 13 is a diagram illustrating a computer network or similar digital processing environment in which embodiments of the present disclosure may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

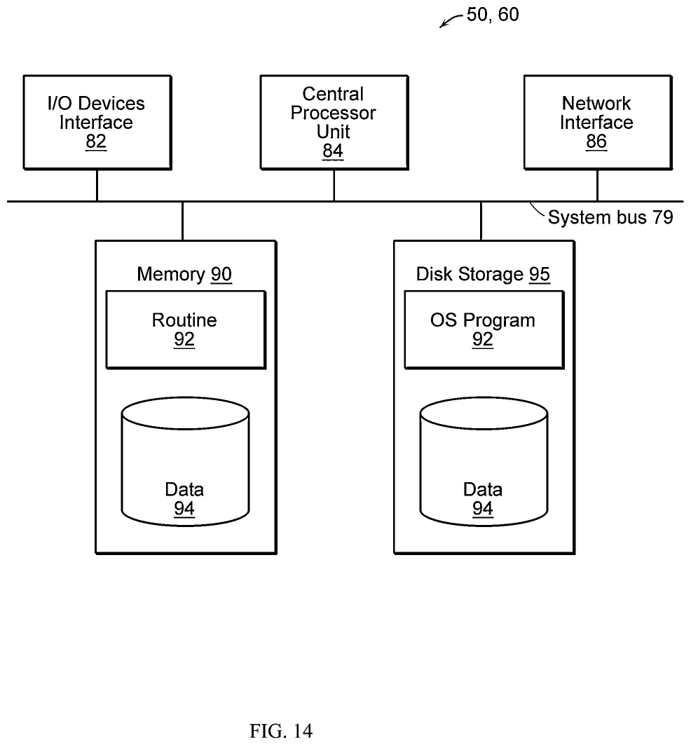

FIG. 14 is a diagram illustrating the internal structure of a computer (e.g., client processor/device 50 or server computers 60) in the computer system of FIG. 13. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 13). Memory 90 provides volatile storage for computer software instructions 92 and data 94 used to implement an embodiment of the present invention (e.g., the inference classification method, system, techniques, and program code detailed above). Disk storage 95 provides non-volatile storage for computer software instructions 92 and data 94 used to implement an embodiment of the present invention. Central processor unit 84 is also attached to system bus 79 and provides for the execution of computer instructions.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method for inference classification, the method comprising:
by a circuit coupled with (i) an item memory, said item memory comprises a value memory configured to store a plurality of binary vectors representing discrete values, and a feature memory configured to store a plurality of query feature positions that are associated with the plurality of binary vectors in the value memory; and (ii) an associative memory configured to store a plurality of predefined class vectors:
mapping each of a plurality of discrete values, loaded from the value memory to a plurality of instances of binary code;
stacking a plurality of value vectors associated with one or more of the plurality of discrete values associated with one or more instances of binary code, such a dimension of the stacked plurality of value vectors matches the dimension of the plurality of value vectors combined with a dimension of the feature vector;
performing a matrix multiplication of the stacked value vectors and the feature vector to produce a sample vector;
generating a comparison result by comparing the sample vector against the plurality of predefined class vectors for similarity checking; and
classifying the sample vector based on the comparison results associated with the similarities between the sample vector and the plurality of predefined class vectors.

2. The method of claim 1 further comprising:
defining a neural network comprising a value layer, a feature layer, and a class layer;
extracting a plurality of value vectors by inputting a plurality of values to the value layer that converts feature values to bipolar value vectors, and recording output of the value layer;
extracting a plurality of feature vectors by recording a binary weight associated with each of the plurality of feature vectors in the feature layer, where said plurality of feature vectors have the same dimension as the value vectors; and
extracting a plurality of class vectors by recording a binary weight associated with each of the plurality of class vectors in the class layer, where said plurality of class vectors have the same dimension as the plurality of value vectors and the plurality of feature vectors; and defining a sample vector as a product of binding the feature vector and the stacked value vectors.

3. The method of claim 1, wherein the circuit is implemented on a tiny device.

4. The method of claim 1, wherein the circuit is a field programmable gate array (FPGA).

5. The method of claim 1, wherein the mapping each of the plurality of discrete values associated with the feature vector to a plurality of instances of binary code, is performed by a trainable binary neural network.

6. The method of claim 5, wherein the binary neural network is trained to optimize the organization of the plurality of instances of binary code by converting the value vectors to a low vector dimension.

7. A method for inference classification, the method comprising:
by a processor coupled with an associative memory:
encoding a class vector for a class of data, the vector being determined by collecting a class of data and encoding the class of data with feature vectors and with value vectors;
calculating a class vector by averaging each of a plurality of hypervectors within the class; and
storing the class vector in the associative memory.

8. The method of claim 7, wherein the class of data is a class of data of a plurality of classes of data.

9. The method of claim 7, further comprising: discarding all non-binary weight associated with the extracted value vectors.

10. The method of claim 7, further comprising: extracting the class vectors from a set of optimized class weight parameters.

11. A system for inference classification, the system comprising:
(i) an item memory, said item memory comprises a value memory configured to store a plurality of binary vectors representing discrete values, and a feature memory configured to store a plurality of query feature positions that are associated with the plurality of binary vectors in the value memory; and (ii) an associative memory configured to store a plurality of predefined class vectors;
a circuit coupled with the value memory, the feature memory, and the associative memory, the circuit configured to:
map a plurality of discrete values associated with a feature vector;
stack a plurality of value vectors associated with one or more of the plurality of discrete values associated with one or more instances of binary code, such a dimension of the stack of plurality of value vectors matches the dimension of the plurality of value vectors combined with a dimension of the feature vector;
compare a sample vector to each of a plurality of predefined class vectors by performing a matrix multiplication, the sample vector being a product of binding the feature vector and the stacked plurality of value vectors;
identifying a respective value associated with similarity between the sample vector and each of the plurality of class vectors; and
classifying the sample vector based on the maximum value associated with similarity with the plurality of predefined class vectors.

12. A method for inference classification, the method comprising:
by a circuit coupled with (i) an item memory, said item memory comprises a value memory configured to store a plurality of binary vectors representing discrete values, and a feature memory configured to store a plurality of query feature positions; and (ii) an associative memory configured to store a plurality of predefined class vectors: combining the plurality of binary vectors with the plurality of query feature positions, resulting in a sample vector;
comparing the sample vector to a plurality of class vectors of a class layer, the comparison of the sample vector to the plurality of class vectors resulting in respective comparison scores for each comparison; and
outputting the comparison scores for classification as an inference label.

13. The method of claim 12, wherein combining the plurality of binary vectors with the plurality of query feature positions further includes:
multiplying each feature vector with each value vector; and
accumulating the result of the multiplying, the accumulation resulting in the sample vector.

14. The method of claim 13, wherein the multiplying and accumulating are performed by an FGPA.

15. The method of claim 12, wherein comparing the sample vector to the plurality of class vectors further includes:
multiplying the sample vector with each class vector; and
averaging the result of the multiplication to a scalar.

16. The method of claim 12, wherein one or more of the value memory, associative memory, and feature memory are 1 MB or less.

17. The method of claim 12, wherein the circuit includes less than 10,000 look up tables (LUTs).
